(19) United States
(12) Patent Application Publication
(10) Pub. No.: US 2009/0003391 A1
(43) Pub. Date: Jan. 1, 2009

(54) Low-repetition-rate ring-cavity passively mode-locked fiber laser

(76) Inventor: Shenping Li, Painted Post, NY (US)

Correspondence Address: CORNING INCORPORATED, SP-TI-3-1, CORNING, NY, 14831, US

(21) Appl. No.: 11/823,680

(22) Filed: Jun. 28, 2007

(51) Int. Cl. H01S 3/30

(52) U.S. Cl. 372/6

(57) ABSTRACT

A ring-cavity, passively mode locked fiber laser capable of producing short-pulse-width optical pulses at a relatively low repetition rate. The fiber laser uses a one-way ring-cavity geometry with a chirped fiber Bragg grating (CFBG) at its reflecting member. The CFBG is part of a dispersion compensator that includes an optical circulator that defines a one-way optical path through the ring cavity. A doped optical fiber section is arranged in the optical path and serves as the gain medium. A pump light source provides the pump light to excite the dopants and cause the gain medium to lase. A saturable absorber is operable to effectuate passive mode-locking of the multiple modes supported by the ring cavity. The ring cavity geometry allows to achieve mode locking with single pulse operation in a longer cavity length than conventional linear cavities. Furthermore, the longer cavity length reduces the constraints on the chirp rate of the CFBG. This, in turn, allows the CFBG to have a relatively high reflectivity, which provides the necessary dispersion compensation and cavity loss for generating short optical pulses at a low repetition rate.

### BACKGROUND OF THE INVENTION

1. Field of the Invention

The present invention relates to fiber lasers, and in particular to passively mode-locked fiber lasers.

2. Technical Background

Short optical pulses (e.g., pulses having a temporal pulse width on the order of picoseconds or shorter) have many important applications in a variety of fields, including laser-based micromachining, thin film formation, laser cleaning, medicine, and biology. Optical pulse fiber laser systems are increasingly displacing traditional solid-state laser systems in applications requiring short optical pulses. A high-energy-pulse fiber laser system typically includes an seed pulse fiber laser and a multiple stage fiber amplifier. Self-started passively mode-locked fiber lasers are ideal pulse seed sources for such laser systems because they are compact, low cost, and have superior mechanical and thermal stability. A mode-locked fiber laser includes a section of doped optical fiber as the gain medium. Different dopants are used to achieve laser operation at different wavelengths from the visible to the infrared (IR). Of particular interest are rare-earth dopants (e.g., Er⁺³ and Yb⁺³) that generate infrared wavelength light useful in optical telecommunications and a number of other applications.

There are two main types of mode locking: active and passive. Active mode locking involves modulating either the amplitude or phase of the intracavity optical field at a frequency that is an integer multiple of the mode spacing. Active mode locking is typically implemented using externally driven intracavity electrooptic and acoustooptic modulators. Passive mode locking involves using one or more nonlinear optical devices inside the resonator to produce an intensity-dependent response to an optical pulse that reduces the pulse width of the optical pulse exiting the nonlinear element. Passive mode locking does not require externally driving the passive mode locking element. Rather, the passive mode-locking element “self starts” the mode locking process by virtue of its non-linear to response to light incident thereon.

For many applications, such as material processing, high pulse energy (e.g., on the order of μJ or higher) or correspondingly high peak power is often required. Because of the limited pump power available for the amplifiers and the high repetition rate (˜30 MHz or higher) of the pulses generated by the seed laser, optical gates are placed between the amplification stages. The optical gates are used to lower the repetition rate of the pulses generated by the seed laser and increasing the maximum energy of the pulses. Low-repetition rate mode-locked fiber lasers are thus desired for applications requiring high-energy laser pulses because, among other things, they obviate the need for the additional high-speed optical gates.

Since the repetition rate of the output pulses from a laser is inversely proportional to the laser cavity length, the repetition rate can be reduced by increasing the cavity length. On the other hand, increasing the fiber cavity length gives rise to detrimental nonlinearities in the optical fiber. This enhances the effect of soliton dynamics, which causes the pulses in the laser cavity to break up through the sideband generation of a periodically perturbed soliton. The pulse intensity in the laser cavity therefore needs to be low enough to avoid such detrimental nonlinearities.

Passive mode-locking can only be achieved when the cavity pulse intensity is higher than the mode-locking threshold intensity. In a passively mode-locked fiber laser with a saturable absorber, this threshold intensity is determined by the cavity configuration and cavity quality, as well as the saturation power of the saturable absorber. Also, every laser cavity contains spurious reflections. Spurious reflections are unwanted reflections that occur within the laser cavity, such as might occur from linear or nonlinear scattering in the optical fiber, or from reflections from fiber connectors or from fiber splices. Spurious reflections can create an intra-cavity Fabry-Perot etalon structure that creates unevenly spaced resonator modes (so-called “etalon effects”).

For mode-locking, the saturable absorber must injection-lock the uneven modes to create an evenly spaced set of oscillating modes. Spurious reflections create injection signals that pull the mode frequencies away from the desired even spacing, thus increasing the mode-locking threshold intensity. Under these conditions, if the absorber signal (or cavity pulse intensity) is too weak, mode-locking will not occur.

What is needed is a passively mode locked fiber laser that overcomes these competing limitations so that the laser can operate at a low repetition rate and produce relatively short output pulses.

### SUMMARY OF THE INVENTION

One aspect of the invention is a passively mode-locked fiber laser apparatus. The apparatus includes a ring cavity formed by an optical fiber closed-loop circuit and a dispersion compensator. The dispersion compensator includes a chirped fiber Bragg grating (CFBG) reflector having a reflectivity R_{CFBG}. The dispersion compensator also includes an optical circulator optically coupled to the CFBG. The ring cavity is capable of supporting multiple cavity modes and has a one-way optical path defined by the direction of the one-way circulator. The apparatus also has a doped optical fiber section arranged in the optical path that is operable to absorb pump light at a pump wavelength and to emit laser light at a laser wavelength different from the pump wavelength. The apparatus further includes a saturable absorber arranged in the optical path and that is operable to effectuate passive mode-locking of the multiple modes to produce optical pulses at the laser wavelength, which is determined by the CFBG. The apparatus also includes a pump light source that provides the pump light to the gain medium.

Another aspect of the invention is a method of producing low-repetition-rate, short-pulse-width optical pulses. The method includes forming an optical fiber ring cavity that has an associated dispersion D_{RC}, a CFBG with a reflectivity R_{CFBG} and a dispersion D_{CFBG} of opposite sign to dispersion D_{RC}. The CFBG is optically coupled to a circulator so that the ring cavity is capable of supporting multiple modes over a one-way optical path. The method also includes disposing in the optical path a section of doped optical fiber as a gain medium that absorbs pump light at a pump wavelength and that emits laser light at a laser wavelength different from the pump wavelength. The method also includes pumping the gain medium with pump light, and disposing a saturable absorber in the optical path so as to provide passive mode-locking of the multiple modes to produce optical pulses at the laser wavelength.

Another aspect of the invention is a ring-cavity passively mode-locked fiber laser apparatus capable of producing optical pulses at a relatively low repetition rate. The apparatus includes a first optical fiber section doped so as to serve as a gain medium that absorbs pump light at a pump wavelength λ_{P} and that emits laser light at a laser wavelength λ_{L}, which is determined by the CFBG, wherein λP≠λ_{L}. The apparatus also includes a saturable absorber that provides an intensity-dependent absorption at the laser wavelength. The apparatus further includes a dispersion compensator having a CFBG with an associated reflectivity R_{CFBG}, a dispersion D_{CFBC} and a circulator optically coupled to the CFBG and configured to define a one-way optical path for laser light around the ring cavity. The doped optical fiber section, saturable absorber and dispersion compensator are optically coupled to one another to form the ring cavity. The ring cavity is capable of supporting multiple cavity modes and has an associated dispersion D_{RC} opposite in sign to D_{CFBG} such that (0.1)|D_{RC}|≦|D_{CFBG}|≦(10)|D_{RC}|. The saturable absorber is operable to effectuate passive mode-locking of the multiple modes to produce at the laser wavelength optical pulses having a repetition rate r_{REP} such that 2 MHz≦r_{REP}≦20 MHz. The apparatus also includes a pump light source optically coupled to the ring laser cavity to provide pump light to pump the gain medium.

Additional features and advantages of the invention will be set forth in the following detailed description, and in part will be readily apparent to those skilled in the art from that description or recognized by practicing the invention as described herein, including the following detailed description, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of a generalized example embodiment of the ring-cavity passively mode-locked fiber laser of the present invention;

FIG. 2 is a schematic diagram similar to FIG. 1, illustrating an example embodiment that includes an attenuator used to tune the cavity loss;

FIG. 3 is a schematic diagram of an example embodiment of the fiber laser based on the generalized embodiment of FIG. 2;

FIG. 4 is an autocorrelation trace of the normalized intensity vs. time (ps) illustrating the pulse width and shape of the optical pulse from the example fiber laser of FIG. 3 for single pulse operation;

FIG. 5 is a plot of the intensity (dB) vs. wavelength (nm) illustrating the optical spectrum of the output pulses of the example fiber laser of FIG. 3 for single-pulse operation; and

FIG. 6 is a schematic diagram of an optical system that uses the ring-cavity passively mode-locked fiber laser of the present invention.

### DETAILED DESCRIPTION OF THE PREFERRED EMBODIMENTS

Reference is now made to the present preferred embodiments of the invention, examples of which is/are illustrated in the accompanying drawings. Whenever possible, the same reference numbers or letters are used throughout the drawings to refer to the same or like parts.

### Generalized Embodiments

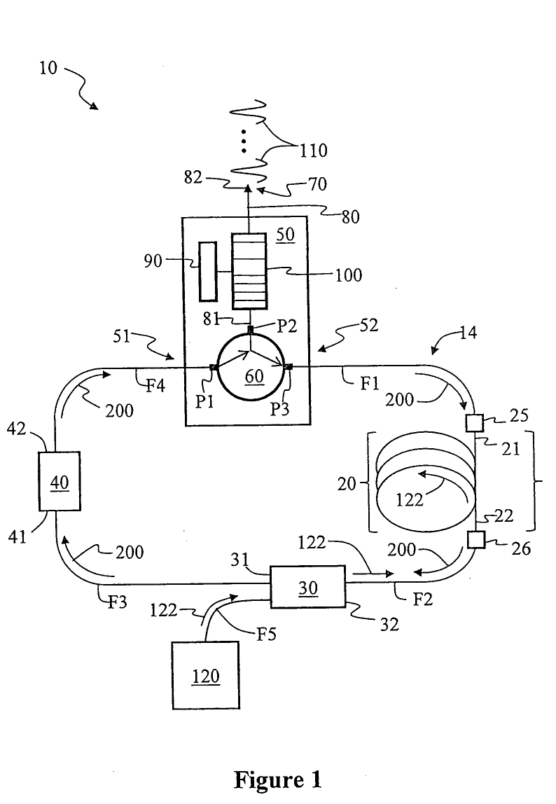

FIG. 1 is a schematic diagram of a general example embodiment of a ring-cavity passively mode-locked fiber laser (“fiber laser”) 10 of the present invention. Fiber laser 10 has a unidirectional optical-fiber-based ring cavity 14 formed from a closed-loop optical circuit. Ring cavity 14 is capable of supporting multiple cavity modes.

In an example embodiment, the closed-loop optical circuit is made up of a number of optical fiber sections (discussed below), including a doped optical fiber section 20 having first and second ends 21 and 22. Doped optical fiber section 20 serves as the gain medium for the laser. In an example embodiment, doped optical fiber section 20 includes one or more rare-earth dopants suitable for use with silica-based media, two such exemplary elements being erbium (Er) and ytterbium (Yb). Doped optical fiber section 20 is operable to absorb pump light at a pump wavelength λ_{P} and emit laser light 200 at a laser wavelength λL different from the pump wavelength.

In an example embodiment, doped optical fiber section 20 has a length ranging from about a few centimeters to about a few meters, depending on the dopant concentration. First and second ends 21 and 22 of doped optical fiber section 20 are optically coupled to respective optical fiber sections F1 and F2 using, for example, respective optical splices 25 and 26.

Fiber laser 10 also includes a wavelength division multiplexer (WDM) 30 having respective input and output ends 31 and 32. Output end 32 is optically coupled to the end of optical fiber F2 opposite splice 26, thereby establishing optical communication between WDM 30 and doped optical fiber section 20.

Fiber laser 10 also includes a saturable absorber 40 having an input end 41 and an output end 42, with input end 41 optically coupled to WDM input end 31 via an optical fiber section F3. A saturable absorber 40 is operable to effectuate self-started passive mode-locking of the multiple cavity modes to produce optical pulses at the laser wavelength λ_{L}. In various example embodiments, saturable absorber 40 is or includes a semiconductor-based nonlinear device (e.g., a semiconductor mirror or SAM or a semiconductor transmission saturable absorber), a carbon-nanotubes-based nonlinear device, or the like.

Fiber laser 10 further includes a dispersion compensator 50 having an input end 51 and an output end 52. Input end 51 is optically coupled to saturable absorber output end 42 via an optical fiber section F4, and output end 52 is optically coupled to the end of optical fiber section F1 that is opposite splice 25, thereby completing the optical fiber circuit that forms ring cavity 14.

In an example embodiment, dispersion compensator 50 includes a three-port circulator 60 that includes an input port P1 corresponding to input end 51, an input/output port P2 that corresponds to a fiber laser output 70, and an output port P3 that corresponds to output end 52. Dispersion compensator 50 includes an optical fiber section 80 having an input end 81 optically coupled to circulator input/output port P2, an opposite output end 82, and a chirped fiber Bragg grating (CFBG) 100 formed in optical fiber section 80 between its input and output ends. CFBG is shown enlarged relative to optical fiber section 80 for the sake of illustration. Output end 82 of optical fiber section 80 corresponds to fiber laser output 70 and serves as a tap for laser pulses 110 generated by fiber laser 10.

CFBG 100 serves a number of functions. One function is to serve as the reflecting member that allows ring cavity 14 to operate as a laser resonant cavity. Another function is to at least partially compensate for the pulse stretching effect of the intra-cavity dispersion D_{RC} (normal or anomalous) that occurs over the one-way optical path of ring cavity 14. To this end, CFBG has a dispersion D_{CFBG} opposite in sign to the intra-cavity dispersion D_{RC}. Thus, where the intra-cavity dispersion stretches the optical pulses, CFBG compensates by compressing the pulses upon reflection. In an example embodiment, (0.1)|D_{RC}|≦|D_{CFBG}|≦(10) |D_{RC}|.

Another function is to serve as a tunable filter to control the lasing wavelength. In this regard, in an example embodiment, dispersion compensator 50 includes a tuning mechanism 90, such as fiber stretching/compressing device, that is operably coupled to CFBG 100 and that provides some degree of adjustability (tuning) to the grating spacing and thus the reflectivity R_{CFBG} of CFBG 100. An example tuning device based on fiber stretching/compressing is described in U.S. patent application Ser. No. 11/495,204, which patent application is incorporated herein by reference. In an example embodiment, the reflectivity R_{CFBG} of CFBG 100 is 20%≦R_{CFBG}≦95%.

Another function of CFBG 100 is to provide output laser pulses 110 at output 70 via transmission of the CFBG.

Fiber laser 10 also includes a pump light source 120 optically coupled to input end 31 of WDM 30 via an optical fiber section F5. Pump light source 120 generates pump light 122 having a pump wavelength λ_{P} that is absorbed by the dopants in doped optical fiber section 20, thus raising the energy level of the dopants to effectuate lasing. Two example pump wavelengths are λ_{P}=980 nm and λ_{P}=1460 nm for an Er-doped optical fiber section 20. In an example embodiment, pump light source 120 is or includes a diode laser.

Because λ_{P}≠λ_{L}, the use of WDM 30 allows for pump light 122 to be introduced into ring cavity 14 and travel counterclockwise (i.e., against the one-way optical path associated with laser light 200) while allowing the laser light to travel clockwise around the ring cavity, as discussed below.

There are two versions of the generalized embodiment of fiber laser 10 as illustrated in FIG. 1. In the first version, the fiber laser 10 uses non-polarization maintaining (non-PM) optical fibers and polarization-insensitive components. This “unpolarized” embodiment generates stable low-repetition-rate un-polarized optical pulses 110.

In the second version, polarization maintaining (PM) or single-polarization (SP) fibers and PM components are employed. This “polarized” embodiment generates stable low-repetition-rate polarized optical pulses 110.

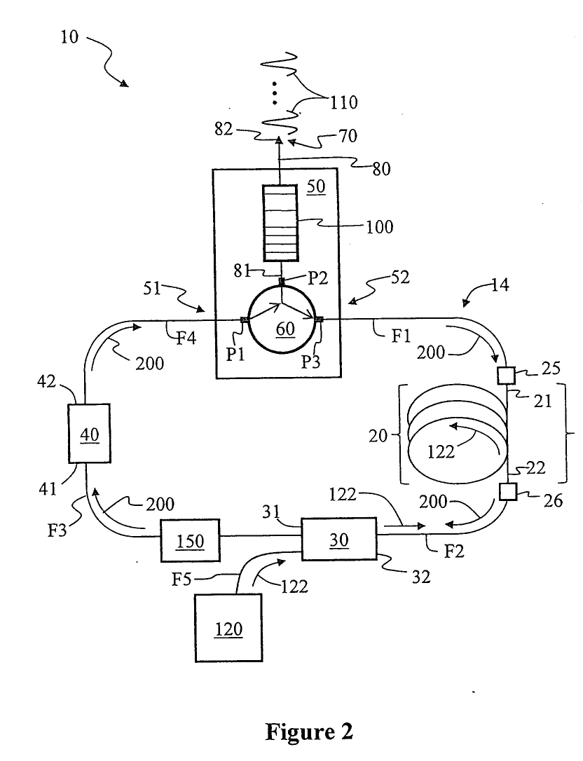

In an example embodiment of fiber laser 10, CFBG 100 is not adjustable, i.e., has a fixed reflectivity R_{CFBG}. Further, reflectivity R_{CFBG} may be greater than the optimal reflectivity R_{OPT} that provides the exact cavity loss needed for optimum system performance. Accordingly, FIG. 2 illustrates an example embodiment of a fiber laser 10 similar to that shown in FIG. 1, but that additionally includes an optical attenuator 150 in ring cavity 14. In an example embodiment, optical attenuator 150 has a fixed attenuation selected based on the value of R_{CFBG}, or more specifically, the difference between the optimal reflectivity R_{OPT} and the actual value R_{CFBG} when R_{CFBG}>R_{OPT}.

In another example embodiment, optical attenuator 150 is a variable optical attenuator whose attenuation is adjusted to optimize the cavity loss. Optical attenuator 150 adds an additional amount of attenuation of laser light 200 and thus increases the cavity loss to make up for any deficiency in the cavity loss that occurs from using a non-optimized reflectivity R_{CFBG} where R_{CGBG}>R_{OPT}.

### Method of Operation

The method of operation of fiber laser 10 is now described. First, pump light source 120 generates pump light 122 at the pump wavelength π_{P}. Pump light 122 travels over optical fiber section F5 to WDM 30, which couples the pump light into optical fiber section F2. Pump light 122 travels counterclockwise to doped optical fiber section 20, where some of the pump light is absorbed by the dopants therein, placing the dopants in their excited state. Laser light 200 of wavelength λ_{L}≠λ_{P} is then emitted in both directions (clockwise and counterclockwise) when the dopants transition to their lower-energy state. The orientation of circulator 60 in dispersion compensator 50 supports light propagation in the clockwise direction around ring cavity 14 while suppressing counterclockwise propagation. Thus, pump light 122 and laser light 200 that travel in the counterclockwise direction around ring cavity 14 are eventually blocked by circulator 60. Circulator 60 thus defines the one-way (e.g., clockwise, as shown) optical path around ring cavity 14.

Note that the “one-way” optical path as the term is used herein ignores the optical path within dispersion compensator 50, namely the small section of optical fiber section 80 between circulator 60 and CFBG 100 where the laser light travels in both directions. The ring cavity optical path is “one-way” in that laser light 200 enters input side 51 of dispersion compensator 50 and exits output side 52 after the laser light reflects from CFBG 100.

The interaction of (clockwise-traveling) laser light 200 with saturable absorber 40 and CFBG 100 in dispersion compensator 50 causes the laser to switch from CW mode to a self-started mode-locked operation at a threshold pump power. When the performance of fiber laser 10 is optimized, the result is a train of output pulses 110 having a repetition rate r_{REP} as low as about 2 MHz and a pulse width Δτ as small as about 70 fs. In an example embodiment, 2 MHz≦r_{REP}≦20 MHz. Also in an example embodiment, 70 fs≦Δτ≦5 ps. Naturally, faster repetition rates r_{REP} are possible using fiber laser 10. However, one of the main benefits of fiber laser 10 of the present invention is that it is capable of providing the harder to achieve and often more desirable lower-repetition-rate/higher-power optical pulses and so is preferably used in such a capacity.

Optimizing the performance of fiber laser 10 involves 1) lowering the cavity loss; 2) improving the quality of the laser cavity to minimize any unwanted intra-cavity reflections; and 3) lowering the saturation power by reducing the light beam size focused on the saturable absorber, and 4) improving the design of the saturable absorber. Reducing the cavity loss, which mainly arises from the insertion loss of optical components used in the laser, can reduce the average cavity pulse power needed saturate the saturable absorber. A lower repetition rate r_{REP} of the pulses is achieved by using a longer fiber cavity, while avoiding pulse breaking due to the detrimental nonlinearities in the optical fiber. As discussed above, improving the laser cavity quality and reducing the saturation power reduces the mode-locking threshold power and reduces the repetition rate r_{REP}.

Compared with mode-locked fiber lasers having linear cavities, the unidirectional ring cavity configuration of fiber laser 10 of the present invention can generate short pulses with a much lower repetition rate. As discussed above, lowering the mode-locking threshold intensity requires suppressing the aforementioned etalon effects. In a linear cavity, an inner Fabry-Perot cavity can be formed by one inner spurious reflector and one of the laser cavity mirrors. However, in a unidirectional ring cavity, an inner Fabry-Perot cavity must be formed by two inner spurious reflectors. Since the reflection of any inner spurious reflector is much smaller than that of the laser cavity mirrors (in a linear laser cavity), etalon effects in a unidirectional ring laser cavity are much smaller than those in a linear laser cavity. Thus, the mode-locking threshold intensity significantly reduced in the present invention via the unidirectional ring cavity.

In addition, compared with mode-locked fiber lasers having linear cavities, the unidirectional ring cavity configuration of fiber laser 10 of the present invention makes it possible to use a CFBG 100 having a lower chirp rate C_{R} (e.g., C_{R}≦150 nm/cm and preferably 15 nm/cm≦C_{R}≦150 nm/cm) than is used in conventional fiber lasers to achieve the shortest pulse-width optical pulses. This because fiber laser 10 of the present invention can have a greater cavity length. This is important because of the tradeoff between high chirp rate and high reflectivity makes it impossible to have high-reflection CFBGs with a high chirp rate.

For an example, it has been shown that the maximum achievable reflectivity R_{CFBG} of a CFBG with a chirp rate C_{R}=150 nm/cm is R_{CFBG}≦25%. This CFBG can produce a dispersion D_{CFGB}=−0.25 ps², which can compensate for the dispersion of about a 6 m length of doped optical fiber section 20 with an associated dispersion D_{F}=−25 ps/nm/km (i.e., the typical dispersion for single mode fiber at 1050 nm). This allows for the construction of a dispersion-compensated Yb-doped fiber laser having a theoretical minimum repetition rate of about 20 MHz.

The present invention relaxes the chirp rate requirement (e.g., in an example embodiment to be less than 150 nm/cm and preferably between 15 nm/cm and 150 nm/cm) and allows for optimizing the operation of the fiber laser by using CFBGs having a higher reflectivity (i.e., at the upper end of the aforementioned range of 20%≦R_{CFBG}≦95%) than is otherwise possible. This, in turn, allows for a lower repetition rate (i.e., r_{REP}≦30 MHz and more preferably at the lower end of the aforementioned range of 2 MHz≦r_{REP}≦20 MHz) and thus shorter pulse-width optical pulses 110 (e.g., preferably within the aforementioned range of 70 fs≦Δτ≦5 ps).

### Specific Example Embodiment

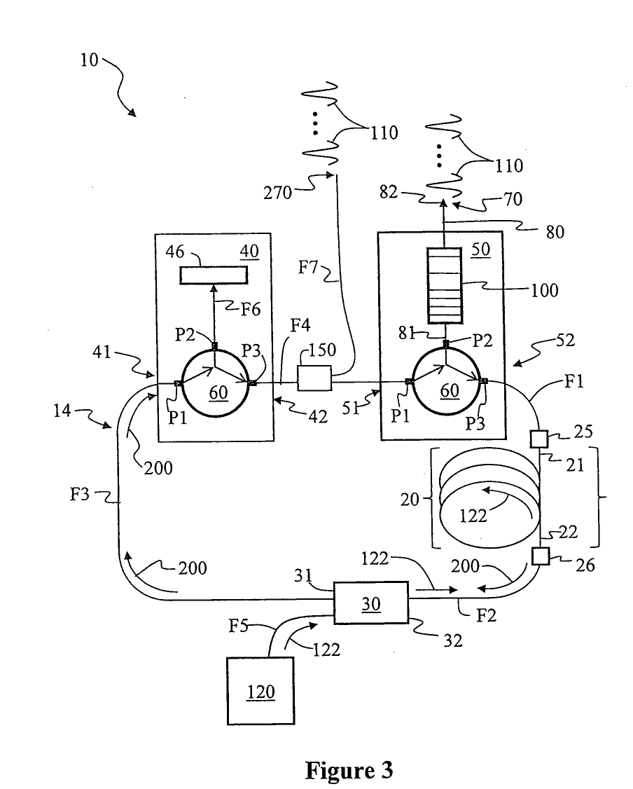

FIG. 3 is a specific example embodiment of the ring-cavity passively mode-locked fiber laser 10 of the present invention as constructed by the inventor based on the above-described generalized embodiments. Saturable absorber 40 was formed using a three-port circulator 60 and a semiconductor-based saturable-absorber mirror (SAM) 46 having a recovery time of about 10 ps. SAM 46 was optically coupled to input/output port P2 via an optical fiber section F6. A highly Yb-doped optical fiber having a length of 1 m was used for doped optical fiber section 20.

CFBG 100 was an off-the-shelf grating having a center wavelength of 1051 nm, a reflectivity of 96%, and a bandwidth of 15.5 nm. While the particular CFBG 100 used did not have optimized properties, it provided good performance and confirmed the basic operating principles of the invention. The various optical fiber sections F1 through F4 and optical fiber section 20 used to form ring cavity 14 had normal dispersion around the 1050 nm wavelength range.

Since the reflectivity R_{CFBG} was fixed and R_{CFBG}>R_{OPT}, an attenuator 150 in the form of an optical coupler was provided between saturable absorber 40 and dispersion compensator 50 to control the cavity loss and improve laser performance. Experiments were performed with different coupling efficiencies and it was found that the highest output power at single-pulse operation was with a 50:50 coupler (3 dB attenuation). An optical fiber section F7 was optically coupled to the output end of the coupler to provide for a secondary laser output 270. This allowed output pulses 110 to be tapped at attenuator 150 and the associated secondary output 270, as well as from output end 70 via transmission through CFBG 100.

To compensate for the normal dispersion D_{RC} associated with the ring cavity optical fibers, CFBG 100 was arranged with its short wavelength side closest to circulator 60. Fiber laser 10 was first operated in CW mode at a pump power of ˜70 mW and a pump wavelength λ_{P}=980 nm. The pump power was then increased. When it reached ˜110 mW, self-starting, stable mode locking operation was achieved at a laser wavelength λ_{L}=1045 nm and was maintained until the pump power reached ˜120 mW. For single-pulse operation, a maximum output average power of 5.5 mW was achieved from secondary output 270.

When the pump power was increased beyond 120 mW, the single cavity pulse split into two cavity pulses due to the adverse effect of the soliton dynamics, which caused the pulse in the laser cavity to break up through the sideband generation of a periodically perturbed soliton.

With single pulse operation, a repetition rate r_{REP}=16.3 MHz with a pulse width Δτ=˜3 ps and an maxium output energy of 0.33 nJ was achieved. This repetition rate is much lower than prior art repetition rates. As discussed above, the pulse repetition rate r_{REP} can be further reduced to a minimum of about 2 MHz and the corresponding pulse width reduced to a minimum of about Δτ=70 fs by optimizing the key parameters of the optical laser, such as the saturation power of saturable absorber 40, the reflectivity and chirp rate of the CFBG 100, and the cavity insertion loss.

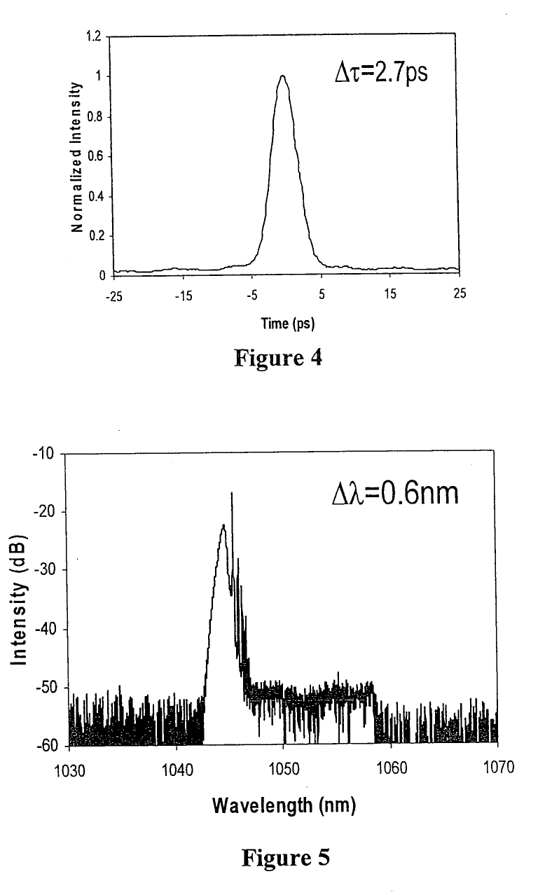

Single-pulse operation of fiber laser 10 of FIG. 3 was verified by measuring output pulses 110 using a combination of a fast detector/sampling scope (<50 ps) and an autocorrelator with a 75 ps scanning range. FIG. 4 is an autocorrelation trace of the resultant measurement plotted as normalized intensity vs. time (ps). The plot reveals a pulse width Δτ=2.7 ps (assuming a sech² profile) and an excellent pulse shape. No multiple-pulse lasing was observed, indicating that the laser operated at the fundamental frequency of the ring laser cavity.

FIG. 5 is a plot of the intensity (dB) vs. wavelength (nm) illustrating the optical spectrum of the output pulses of the example fiber laser 10 of FIG. 3 for single-pulse operation. The 3 dB output spectral width AX ˜0.6 nm around a central wavelength λ_{L} ˜1045 μm, giving a time-bandwidth product of 0.4. The laser operation was very stable, and the laser was found to have robust self-starting over a relatively wide range of pump light input power.

### Optical System

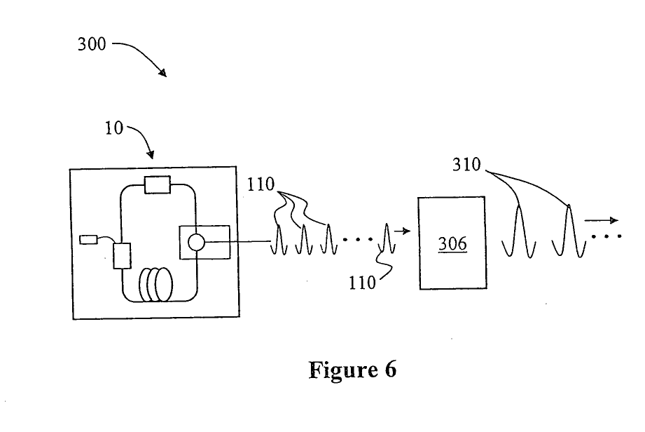

FIG. 6 is a schematic diagram illustrating an example embodiment of an optical system 300 that utilizes fiber laser 10 of the present invention. In optical system 300, fiber laser 10 is optically coupled to an optical processing system 306 adapted to receive and process optical pulses 110. In an example embodiment, optical system 306 is a chirped-pulse fiber amplication system and fiber laser 10 serves as a seed laser that allows optical system 306 to create high energy pulses 310.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A passively mode-locked fiber laser apparatus, comprising:
a ring cavity formed by an optical fiber closed-loop circuit and a dispersion compensator that includes a chirped fiber Bragg grating (CFBG) reflector having a reflectivity R_{CFBG} and a first optical circulator optically coupled thereto, the ring cavity capable of supporting multiple cavity modes and having a one-way optical path defined by said first one-way circulator;
a doped optical fiber section arranged in the optical path and operable to absorb pump light at a pump wavelength and emit laser light at a laser wavelength different from the pump wavelength;
a saturable absorber arranged in the optical path and operable to effectuate passive mode-locking of the multiple modes to produce optical pulses at said laser wavelength; and
a pump light source that provides said pump light to the gain medium.

2. The apparatus of claim 1, wherein the CFBG has a chirp rate C_{R} of 15 nm/cm≦C_{R}≦150 nm/cm.

3. The apparatus of claim 1, wherein 20%≦R_{CFBG}≦95%.

4. The apparatus of claim 1, further including a wavelength-division multiplexer (WDM) that optically couples the pump light source to the ring laser cavity while allowing the laser light to travel over the one-way optical path.

5. The apparatus of claim 1, wherein the saturable absorber includes a semiconductor saturable-absorbing mirror (SAM) operably coupled to a second circulator that is operably arranged in the optical path and configured to allow the laser light to travel over the one-way optical path.

6. The apparatus of claim 1, wherein the saturable absorber includes a semiconductor-based transmission saturable absorber.

7. The apparatus of claim 1, wherein the saturable absorber is a carbon-nanotubes-based nonlinear device.

8. The apparatus of claim 1, wherein the optical pulses have a repetition rate r_{REP} such that 2 MHz≦r_{REP}≦20 MHz.

9. The apparatus of claim 1, wherein the doped optical fiber section is doped with at least one rare-earth element.

10. The apparatus of claim 1, wherein the optical pulses have a pulse width Δτ such that 70 fs≦Δτ≦5 ps.

11. The apparatus of claim 1, wherein:
the pump light produces polarized pump light; and
the optical fiber closed loop circuit, the saturable absorber and the dispersion compensator are either polarization maintaining or have a single-polarization configuration such that the optical pulses are polarized.

12. A method of producing low-repetition rate, short optical pulses, comprising:
forming an optical fiber ring cavity having an associated dispersion D_{RC}, a chirped fiber Bragg grating (CFBG) with a reflectivity R_{CFBG} and a dispersion D_{CFBG} of opposite sign to dispersion D_{RC}, the CFBG being optically coupled to a circulator so that the ring cavity is capable of supporting multiple modes over a one-way optical path;
disposing in the optical path a section of doped optical fiber as a gain medium that absorbs pump light at a pump wavelength and that emits laser light at a laser wavelength different from the pump wavelength;
pumping the gain medium with pump light; and
disposing a saturable absorber in the optical path so as to provide passive mode-locking of the multiple modes to produce optical pulses at said laser wavelength.

13. The method of claim 12, wherein 2 MHz≦r_{REP}≦20 MHz.

14. The method of claim 12, including adjusting the dispersion D_{CFBG} and/or reflectivity wavelength of the CFBG by stretching or compressing the CFBG.

15. The method of claim 12, wherein (0.1)|D_{RC}|≦|D_{CFBG}|≦(10)|D_{RC}|.

16. A ring-cavity passively mode-locked fiber laser apparatus capable of producing optical pulses at a relatively low repetition rate r_{REP}, comprising:
a first optical fiber section doped so as to serve as a gain medium that absorbs pump light at a pump wavelength λ_{P} and that emits laser light at a laser wavelength λ_{L} wherein λ_{P}≠λ_{L};
a saturable absorber that provides an intensity-dependent absorption at the laser wavelength;
a dispersion compensator having a chirped fiber Bragg grating (CFBG) with an associated reflectivity R_{CFBG}, a dispersion D_{CFBG}, and a circulator optically coupled to the CFBG and configured to define a one-way optical path for the laser light around the ring cavity;
wherein the doped optical fiber section, saturable absorber and dispersion compensator are optically coupled to one another to form the ring cavity, the ring cavity capable of supporting multiple cavity modes and having an associated dispersion D_{RC} opposite in sign to D_{CFBG} and such that 0.1|D_{RC}|≦|D_{CFBG}|≦10|D_{RC}|;
wherein the saturable absorber is operable to effectuate passive mode-locking of the multiple modes to produce at said laser wavelength optical pulses having 2 MHz≦r_{REP}≦20 MHz; and
a pump light source optically coupled to the ring laser cavity so as to provide the pump light to pump the gain medium.

17. The apparatus of claim 16, wherein 20%≦R_{CFBG}≦95%.

18. The apparatus of claim 16, wherein the CFBG has a chirp rate C_{R} of 15 nm/cm≦C_{R}≦150 nm/cm.

19. The apparatus of claim 16, wherein the saturable absorber includes a semiconductor saturable-absorbing mirror (SAM).

20. The apparatus of claim 16, wherein the saturable absorber is a carbon-nanotubes-based nonlinear device.
